(19) United States
(12) Patent Application Publication
(10) Pub. No.: US 2014/0340507 A1
(43) Pub. Date: Nov. 20, 2014

(54) METHOD OF MEASURING NARROW RECESSED FEATURES USING MACHINE VISION

(71) Applicant: ELECTRO SCIENTIFIC INDUSTRIES, INC., Portland, OR (US)

(72) Inventor: Kyung Young KIM, Portland, OR (US)

(73) Assignee: ELECTRO SCIENTIFIC INDUSTRIES, INC., PORTLAND, OR (US)

(21) Appl. No.: 14/277,502

(22) Filed: May 14, 2014

Related U.S. Application Data
(60) Provisional application No. 61/824,545, filed on May 17, 2013.
(60) Provisional application No. 61/824,555, filed on May 17, 2013.

(51) Int. Cl. H04N 7/18

(52) U.S. Cl. CPC H04N 7/183
USPC 348/94

(57) ABSTRACT

Deep narrow gaps (20) between side walls (32 and 36) of a workpiece (26) can be measure by modules (42) that include an imager (70) and provide focused directional lighting from light sources (76) into the gaps (20). The imager (70) may employ a camera having an array of pixels along rows and columns. Gray scale captured by pixels along rows or columns parallel to a major axis (46) of the gap (20) may be analyzed to facilitate determination of spacing between the edges (34 and 38) of the gaps (20). Relative movement between the workpiece (26) and the imager (76) along the major axis (46) can also facilitate determination of spacing between the edges (34 and 38) of the gaps (20).

### CROSS REFERENCE TO RELATED APPLICATION

This application is a non-provisional application of U.S. Provisional Patent Application No. 61/824,545, which was filed on May 17, 2013, and this application is a non-provisional application of U.S. Provisional Patent Application No. 61/824,555, which was filed on May 17, 2013, the contents of both U.S. Provisional Patent Application No. 61/824,545 and U.S. Provisional Patent Application No. 61/824,555 are herein incorporated by reference in their entirety for all purposes.

### COPYRIGHT NOTICE

©2014 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This application relates to systems and methods for measuring recessed features of a workpiece and, in particular, to systems and methods for measuring narrow gaps between adjacent components.

### BACKGROUND

The manufacture of consumer electronics devices has become a very competitive marketplace. In addition to technological differences between electronic devices, the user experience is becoming partly defined by the cosmetic appearance of the devices and the tactile sensations evoked by handling the devices. Thus, device manufacturers are continually trying to make advances in the look and feel of their devices.

During the manufacturing process, it is common for several components of a consumer electronic device to be mated together such that the interacting features between mating surfaces is very small, verging on invisible to the eye and/or undetectable by touch. These surfaces may include an enclosure and/or the glass display screen or touch-screen user interface. As this interface continues to be driven to smaller and smaller dimensions, legacy inspection methods, such as those employing conventional machine vision, 2-dimensional and 3-dimensional laser sensors, or touch stylus, are barely adequate to determine the size or even existence of physical features that can still be detected by human visual or tactile senses.

### SUMMARY

This summary is provided to introduce a selection of concepts in a simplified form that are further described in the detailed description of exemplary embodiments. This summary is not intended to identify key or essential inventive concepts of the claimed subject matter, nor is it intended for determining the scope of the claimed subject matter.

Some embodiments employ a method for measuring a first dimension along a first minor axis of a feature adjacent to a first edge of a first surface of a workpiece, wherein the first surface has a first plane, wherein the feature includes a length along a major axis that is transverse to the first minor axis, wherein the feature has a second dimension along a second minor axis that is transverse to the major axis and the first minor axis, wherein the second dimension extends from the first surface to a recessed surface of the feature, wherein the recessed surface of the feature has a recessed plane, wherein an imager having a field of view of an inspection area is employed, wherein the workpiece is positioned in an inspection position such that the first minor axis of the feature is located within the field of view of the imager, wherein directional light is propagated onto the feature such that a major portion of the directional light entering the field of view of the imager propagates into the field of view between the recessed plane and the first plane, wherein the imager captures an image of light reflected from the recessed surface of the feature, and wherein differences in luminance and/or color between the recessed surface of the feature and the surface of the workpiece are analyzed to facilitate determination of a measurement of the first dimension of the feature.

Some additional or cumulative embodiments employ a method for measuring a width along a first minor axis of a gap between a first edge of a first upper surface and a second edge of a second upper surface of a workpiece, wherein the first upper surface has a first upper elevation, wherein the second upper surface has a second upper elevation, wherein the gap includes a length along a major axis that is transverse to the first minor axis, wherein the gap has a depth along a second minor axis that is transverse to the major axis and the first minor axis, wherein the depth extends from at least one of the upper surfaces to a bottom of the gap, wherein the bottom of the gap has a bottom elevation, wherein an imager having a field of view of an inspection area is employed, wherein the workpiece is positioned in an inspection position such that the first minor axis of the gap is located within the field of view of the imager, wherein directional light is propagated into the gap such that a major portion of the directional light entering the field of view propagates into the field of view between the bottom elevation and the first upper elevation or the second upper elevation, wherein the imager captures an image of light reflected from the bottom of the gap, and wherein differences in luminance and/or color between the bottom and the upper surfaces are analyzed to facilitate determination of a measurement of the width of the gap.

In some additional or cumulative embodiments, the directional light is focused into the gap.

In some additional or cumulative embodiments, the width of the gap and the depth of the gap are shorter than the length of the gap.

In some additional or cumulative embodiments, the width of the gap is shorter than the depth of the gap.

In some additional or cumulative embodiments, the field of view has a width dimension that is coplanar with the first minor axis of the gap, and the width dimension of the field of view is shorter than five times the width of the gap.

In some additional or cumulative embodiments, the imager includes an array of pixels along rows and columns, the pixels convey gray scale or intensity information of the image, and analyzing differences includes grouping the gray scale or intensity information by rows of pixels parallel to facilitate determination of spacing between the first and second edges.

In some additional or cumulative embodiments, the imager includes an array of pixels along rows and columns employed to capture the image, the pixels convey gray scale or intensity information of the image, and analyzing differences includes averaging the gray scale or intensity information captured by pixels along rows or columns to facilitate determination of spacing between the first and second edges.

In some additional or cumulative embodiments, an imager having an array of pixels along rows and columns is employed to capture the image, and relative movement between the workpiece and the imager along the major axis is implemented to facilitate determination of spacing between the first and second edges.

In some additional or cumulative embodiments, the field of view has a central imager axis extending from the imager, the directional light has a central lighting axis extending from a light source, and the lighting axis intersects the imager axis.

In some additional or cumulative embodiments, the directional light has a central lighting axis extending from a light source, and the lighting axis has a vector component that is parallel to the major axis.

In some additional or cumulative embodiments, the lighting axis is a first lighting axis, propagating the directional light includes propagating directional light along a second lighting axis, the first and second lighting axes enter the gap from different directions, the first edge defines a first plane that is generally perpendicular to the first surface, the second edge defines a second plane that is generally perpendicular to the second surface, the first lighting axis is positioned within a third plane between the first and second planes, the second lighting axis is positioned within a fourth plane between the first and second planes, and the first and second lighting axes are oriented at nonperpendicular angles with respect to the first or second surfaces.

In some additional or cumulative embodiments, the first lighting axis is positioned within a fifth plane that is transverse to the third plane, the second lighting axis is positioned within a sixth plane that is transverse to the fourth plane, and the fifth and sixth planes intersect each other below the bottom of the gap.

In some additional or cumulative embodiments, the first lighting axis is positioned within a fifth plane that is transverse to the third plane, the second lighting axis is positioned within a sixth plane that is transverse to the fourth plane, and the fifth and sixth planes intersect each other above the bottom of the gap.

In some additional or cumulative embodiments, the first and second surfaces have different elevations with respect to the bottom of the gap.

In some additional or cumulative embodiments, the width is between zero and 500 μM.

In some additional or cumulative embodiments, the depth is between 500 μm and 2 mm.

In some additional or cumulative embodiments, the light source comprises an LED, an optical fiber, or a laser.

In some additional or cumulative embodiments, the workpiece includes a plurality of gaps, including first and second gaps that are transversely aligned, wherein capturing the image employs a camera, wherein the camera and the light source form an inspection module, and wherein the first and second gaps are inspected by separate inspection modules.

In some additional or cumulative embodiments, the workpiece includes a plurality of gaps, including first and second gaps that are transversely aligned, wherein capturing the image employs a camera having an array of pixels along rows and columns, wherein the array of pixels is divided into a plurality of imaging fields including first and second imaging fields, wherein the first imaging field captures a first image of the first gap, and wherein the second imaging field captures a second image of the second gap.

In some additional or cumulative embodiments, the first surface has a first elevation with respect to the bottom of the gap, wherein the second surface has a second elevation with respect to the bottom of the gap that is different from the first elevation, wherein the different first and second elevations define a protrusion, wherein capturing the image employs a camera having an array of pixels along rows and columns, wherein the array of pixels is divided into a plurality of imaging fields including first and second imaging fields, wherein the first imaging field captures the image of the gap, wherein the second imaging field captures a second image of the protrusion, and wherein data from the second image is used to determine a height difference between the first and second elevations.

Some additional or cumulative embodiments, employ a system for measuring a width along a first minor axis of a gap between a first edge of a first upper surface and a second edge of a second upper surface of a workpiece, wherein the first upper surface has a first upper elevation, wherein the second upper surface has a second upper elevation, wherein the gap includes a length along a major axis that is transverse to the first minor axis, wherein the gap has a depth along a second minor axis that is transverse to the major axis and the first minor axis, wherein the depth extends from at least one of the first or second upper surfaces to a bottom of the gap, wherein the bottom of the gap has a bottom elevation, wherein the width and depth are shorter than the length, wherein an imager has a field of view of an inspection area for capturing an image of light reflected from the bottom of the gap, wherein a lighting system is operable for emitting directional light to illuminate to the bottom of the gap, wherein the lighting system is operable to direct the directional light to enter the field of view of the imager such that a major portion of the directional light entering the field of view is directed to enter the field of view between the bottom elevation and the first upper elevation or the second upper elevation, wherein a workpiece positioning mechanism is operable for positioning the workpiece in an inspection position such that the first minor axis of the gap is located within the field of view of the imager, and wherein processing circuitry is operable for analyzing differences in luminance and/or color between the bottom surface and the first and second upper surfaces to facilitate determination of a measurement of the width of the gap.

Some additional or cumulative embodiments employ a method for measuring a first dimension along a first minor axis of a first feature adjacent to a first edge of a first surface of a workpiece and for measuring and for measuring a third dimension along a third minor axis of a second feature adjacent to a second edge of a second surface of the workpiece, wherein the first surface has a first plane, wherein the first feature includes a first length along a first major axis that is transverse to the first minor axis, wherein the first feature has a second dimension along a second minor axis that is transverse to the first major axis and the first minor axis, wherein the second dimension extends from the first surface to a first recessed surface of the first feature, wherein the first recessed surface of the first feature has a first recessed plane, wherein the second surface has a second plane, wherein the second feature includes a second length along a second major axis that is transverse to the third minor axis, wherein the second feature has a fourth dimension along a fourth minor axis that is transverse to the second major axis and the third minor axis, wherein the fourth dimension extends from the second surface to a second recessed surface of the second feature, wherein the second recessed surface of the second feature has a second recessed plane, wherein the first and second recessed planes are transverse, wherein an imager having a field of view of an inspection area is employed, wherein the workpiece is positioned in an inspection position such that the first minor axis of the first feature is located within the field of view of the imager, wherein a mirror is employed to divert a portion of the field of view such that the third minor axis of the second feature is located within the diverted portion of the field of view of the imager, wherein directional light is propagated onto the first and second features, wherein the imager captures a first image of light reflected from the first recessed surface of the first feature on a first imaging region of the imager, wherein the imager simultaneously or sequentially captures a second image of light reflected from the second recessed surface of the second feature on a second imaging region of the imager, wherein differences in luminance and/or color between the first recessed surface of the first feature and the first surface of the workpiece are analyzed to facilitate determination of a first measurement of the first dimension of the first feature, and wherein differences in luminance and/or color between the second recessed surface of the second feature and the second surface of the workpiece are analyzed to facilitate determination of a second measurement of the third dimension of the second feature.

One of many advantages of these embodiments is that deep and narrow gaps can be measured quickly, accurately, and inexpensively.

Additional aspects and advantages will be apparent from the following detailed description of preferred embodiments, which proceeds with reference to the accompanying drawings.

### BRIEF DESCRIPTION OF THE DRAWINGS

FIG. 1 is a cross-sectional view illustrating a gap between two components of a workpiece, such as a mechanical assembly.

FIG. 2A is a top plan view of an exemplary embodiment of an inspection system for inspecting the gap shown in FIG. 1.

FIG. 2B is a side view of the inspection system of FIG. 1 along a plane that is transverse to a major axis of the gap.

FIG. 2C is a cross-sectional view of the inspection system along a plane that is parallel to an edge of the gap.

FIG. 2D is a top plan view of an alternative exemplary embodiment of a radiation pattern from a single light source of the inspection system.

FIG. 2E is a top plan view of an alternative exemplary embodiment of a radiation pattern from a different direction than that of the single light source in FIG. 2E.

FIG. 2F is a top plan view of an alternative exemplary embodiment of a radiation pattern from both the light sources shown in FIGS. 2D and 2E.

FIG. 3A is a top plan view of an embodiment of the inspection system wherein multiple gap locations are aligned with multiple respective fields of view of modules to permit the multiple gap positions to be inspected simultaneously.

FIG. 3B is a top view showing misalignment of two components of the workpiece such that the widths of the gaps at the gap positions are different.

FIGS. 4A-4D are prior art images of gaps between components of a workpiece illuminated by area lighting whose radiation pattern impinges substantially the entire upper surfaces of the components forming the gaps.

FIG. 5A is an image of a gap between components of a workpiece illuminated by directional lighting whose radiation pattern impinges substantially only the gap within the field of view of the imager.

FIG. 5B is an image of two abutting components of the workpiece illuminated by directional lighting whose radiation pattern impinges the workpiece substantially outside the field of view of the imager.

FIG. 6 illustrates an image of a gap between components of a workpiece similar to those schematically illustrated in FIGS. 2A-2F.

FIG. 7 is a top plan view of an exemplary embodiment of an inspection system adapted to inspect multiple features, such as gaps and protrusions, of a workpiece from different directions.

FIG. 8 is an illustration of an imaging field of an imager operable for capturing images of the gap and the protrusion in different imaging regions.

FIGS. 9A and 9B are respective top and side views of an alternative exemplary embodiment of an inspection system adapted to inspect multiple features, such as gaps and protrusions, of a workpiece from different directions.

FIG. 10 is a top view of another alternative embodiment of an inspection system adapted to inspect multiple features, such as a top feature and a side feature, of a workpiece from different directions.

FIG. 11 is a top view of another alternative embodiment of an inspection system adapted to inspect multiple features at multiple separate locations on a workpiece.

### DETAILED DESCRIPTION OF EXEMPLARY EMBODIMENTS

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete and will convey the scope of the disclosure to those skilled in the art. In the drawings, the sizes and relative sizes of components may be disproportionate and/or exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

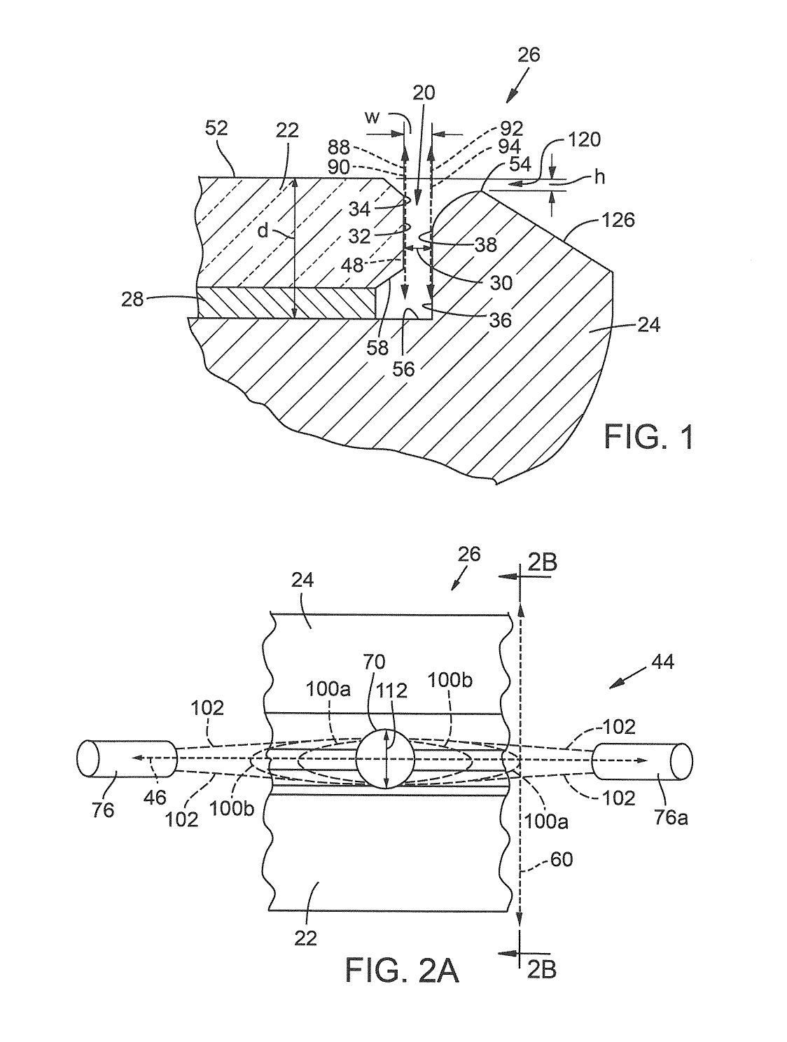

FIG. 1 is a cross-sectional side elevation view illustrating a feature, such as a gap 20, between two components 22 and 24 of a workpiece 26, such as a mechanical assembly. In some embodiments, the workpiece 26 may be an electronic device such as a mobile phone, tablet, or laptop computer. In the exemplarily illustrated embodiment, the component 22 comprises a glass plate and the component 24 comprises a housing. In some embodiments, the components 22 and 24 may be fixed together by means of an adhesive layer 28, such as tape or glue, but they may be fixed or otherwise secured to each other by any suitable or beneficial means.

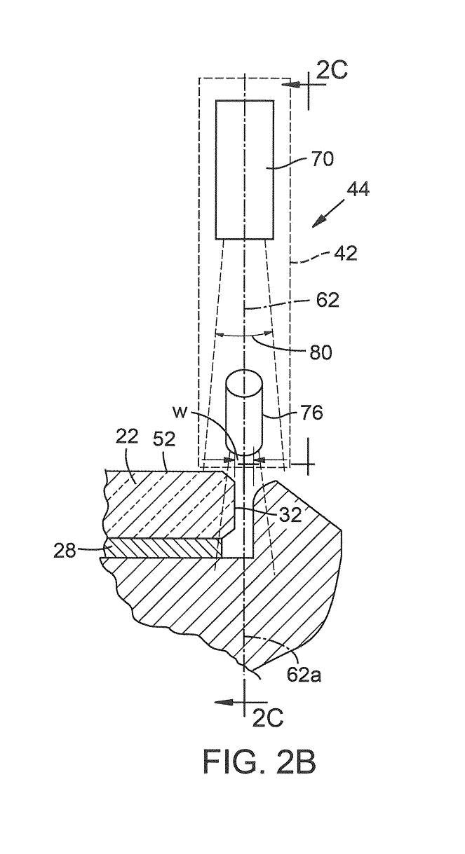

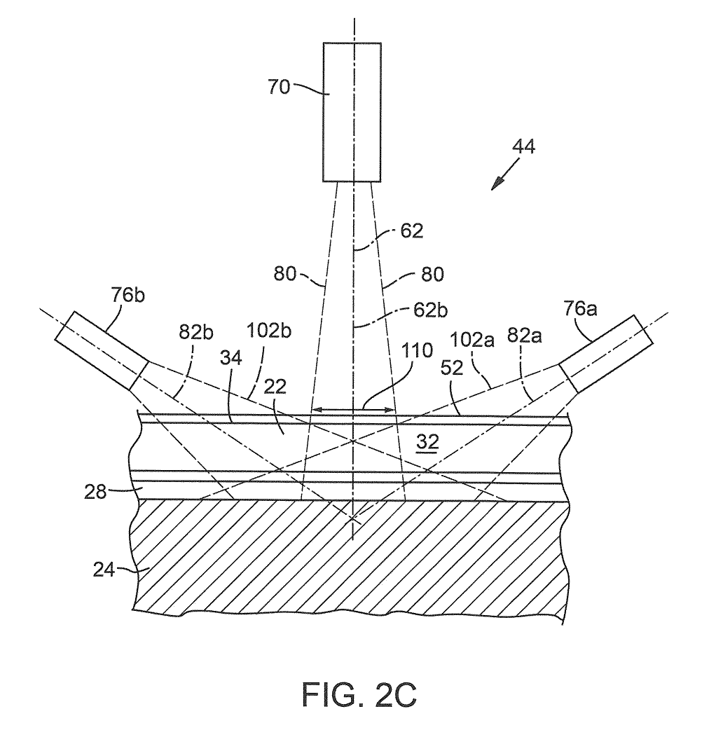

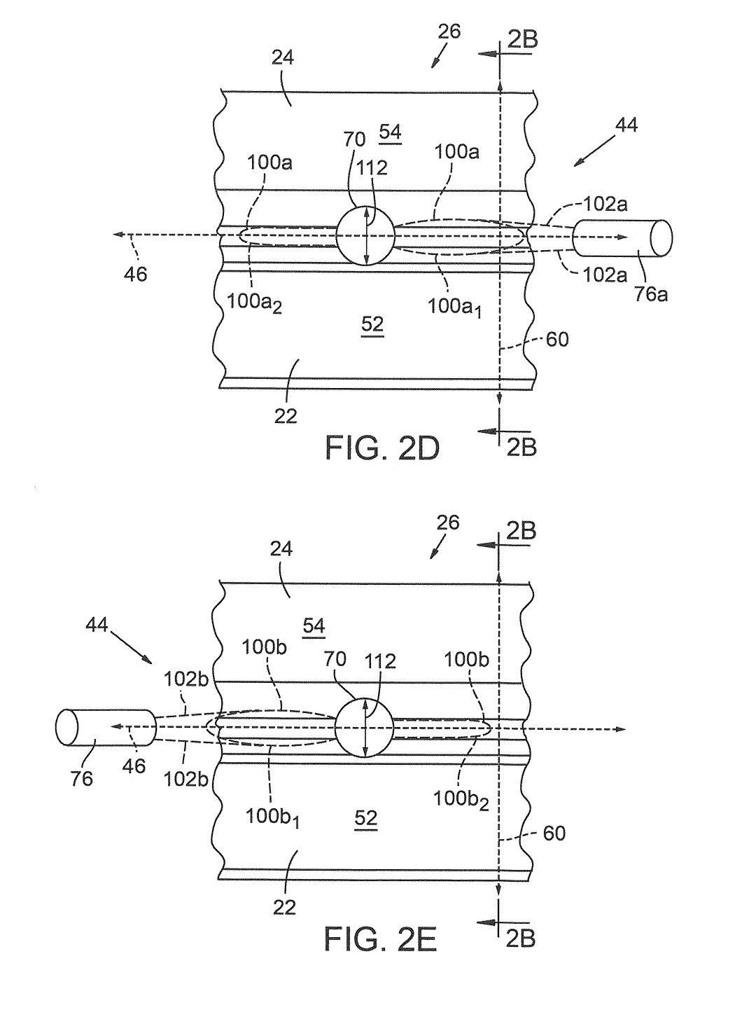

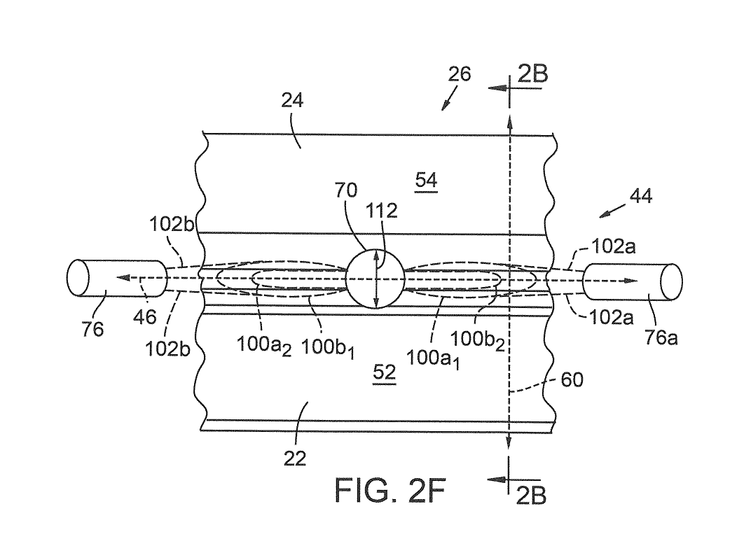

In some embodiments, the gap 20 includes width “w” along a first minor axis 30 that is transverse to a side wall 32 the component 22 that defines an edge 34 of the component 22. In such embodiments, the first minor axis 30 is also transverse to a side wall 36 the component 24 that defines an edge 38 of the component 24. In some preferred embodiments, the first minor axis 30 is perpendicular to the side walls 32 and 36, and the width of the gap 20 is the shortest distance between the side walls 32 and 36 within an inspection area of an inspection module 42 (FIG. 2B) of an inspection system 44 (FIG. 2A).

In some embodiments, the gap 20 includes a length (not shown) along a major axis 46 that is transverse to the first minor axis 30. In some embodiments, the major axis 46 is perpendicular to the first minor axis 30. In some embodiments, the length of the gap 20 is a major distance along a side of the component 22 or a major distance along a side of the component 24.

In some embodiments, the gap 20 includes a depth “d” along a second minor axis 48 that is transverse to the major axis 46 and transverse to the first minor axis 30, such that the depth extends from at least one of an upper surface 52 of component 22 or an upper surface 54 of component 24 to a bottom 56 of the gap 20. In some embodiments, the upper surface 52 and the upper surface 54 have different elevations with respect to the bottom 56 of the gap 20. In some embodiments, the second minor axis 48 is perpendicular to the major axis 46 and perpendicular to the first minor axis 30. In some embodiments, the length, width, and depth define a gap volume. In some embodiments, the width and depth are shorter than the length. In some embodiments, the width is shorter than the depth. One will appreciate that the width of the gap 20 does not include a nongap portion of the bottom surface under an overhang portion 58 of the component 22.

In some embodiments, the gap 20 may have a width that is between zero and 500 μm. In some embodiments, the width is shorter than 200 μm and greater than 0 μm. In some embodiments, the width is shorter than 180 μm and greater than 0 μm. In some embodiments, the width is shorter than 150 μm and greater than 0 μm. In other embodiments, the width is shorter than 125 μm and greater than 0 μm. In yet other embodiments, the width is shorter than 100 μm and greater than 0 μm. In still other embodiments, the width is shorter than 90 μm and greater than 0 μm. In still other embodiments, the width is shorter than 45 μm and greater than 0 μm. In some other embodiments, the width could be greater than 500 μm.

In some embodiments, the gap 20 may have a depth that is between 200 and 2000 μm. In some embodiments, the depth is greater than 500 μm. In some embodiments, the depth is greater than 750 μm. In some embodiments, the depth is greater than 1000 μm. In other embodiments, the depth is greater than 1250 μm. In yet other embodiments, the depth is greater than 1500 μm. In still other embodiments, the depth is greater than 1750 μm. In still other embodiments, the depth could be greater than 2000 μm. In some embodiments, the depth can be shorter than 200 μm.

One problem to solve is the ability to inspect a feature of a workpiece 26 that is at the limits of conventional (and relatively inexpensive) inspection methods. In this regard, FIG. 2A is a top plan view of an exemplary embodiment of an inspection system 44 for inspecting the gap 20 shown in FIG. 1. FIG. 2B is a side view of the inspection system 44 along section lines 2B-2B of FIG. 2A and along a plane 60 (into the page along section lines 2B-2B) that is transverse to the major axis 46 of the gap 20. FIG. 2C is a cross-sectional view of the inspection system 44 along section lines 2C-2C of FIG. 2B and along a plane 62a (into the page along the lower section lines 2C-2C) that is parallel to the side wall 32 of the component 22 or parallel to the side wall 36 of the component 24. In some embodiments, the plane 62a is coplanar with a central imager axis 62 of an imager 70. In some embodiments, the central imager axis 62 also defines a plane 62b that includes the central axis 62 and is transverse to the plane 62a.

With reference to FIGS. 2A, 2B, and 2C, some embodiments of the inspection system 44 include one or more modules 42 that include one or more imagers 70 and one or more light sources 76 that are operable to provide directional light. In some embodiments, the inspection system 44 is housed within and an enclosure (not shown) to control or eliminate ambient light from reaching the upper surfaces 52 and 54. In some embodiments, each inspection module 42 includes a single imager 70 to capture a field of view 80 and a pair of light sources 76a and 76b to illuminate the gap 20 within the field of view 80 from opposing sides of the gap 20 transverse or perpendicular to the edges 34 and 38 of the gap 20. Propagating directional light from two or more different directions into the field of view 80 to overlap on the bottom 56 of the gap 20 removes microshading along the bottom 56 and helps make the bottom 56 of the gap 20 uniformly bright.

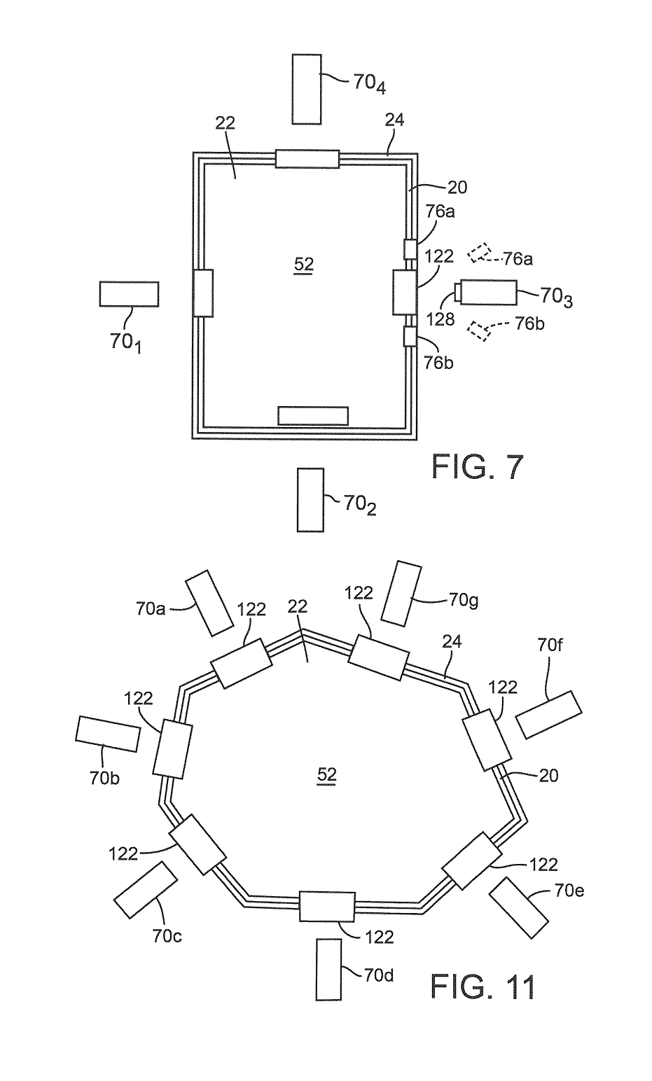

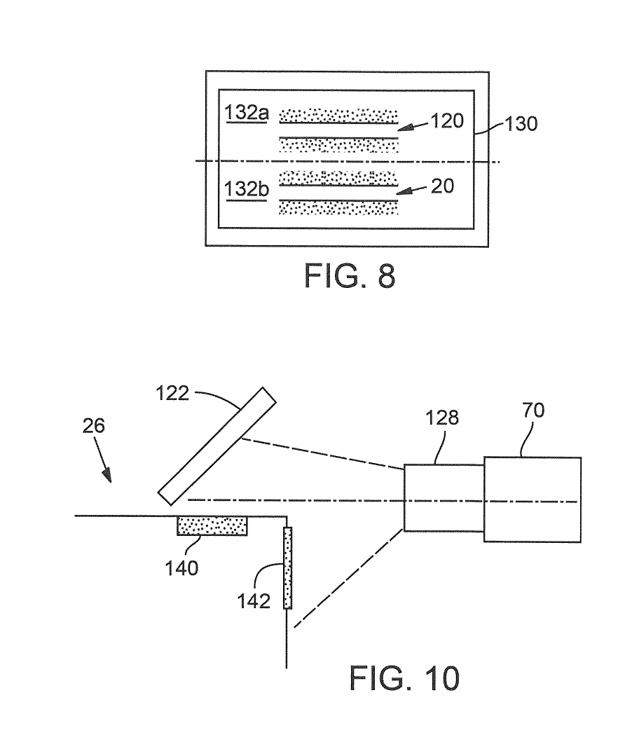

In some embodiments, as later described in more detail, fold mirrors 122 (FIG. 7) can be employed to divert the field of view 80 of an imager 70 to capture the image of more than one gap 20 on the imaging field 130 (FIG. 8) of the imager 70. In some embodiments, the fold mirrors 122 can be employed to divert directional light from a single light source to illuminate the gap 20 from opposing sides of the gap 20 transverse or perpendicular to the edges 34 and 38 of the gap 20.

The directional light can be structured or unstructured light, coherent or incoherent light, polarized or unpolarized light, or a combination thereof. The directional light can be temporally or spatially shaped. The directional light can include any single wavelength, multiple specific wavelengths, or a broad spectrum of wavelengths. In some embodiments, the directional light is focused toward the gap 20 using one or more conventional optical components (not shown).

In some embodiments, a major portion of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 75% of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 80% of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 90% of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 95% of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 99% of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, 100% of the directional light entering the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24.

In some embodiments, a major portion of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 75% of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 80% of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 90% of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 95% of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, greater than 99% of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 55 or the edge 38 of the component 24. In some embodiments, 100% of the directional light illuminating the field of view 80 of the imager 70 propagates into the field of view 80 between the bottom 56 of the gap 20 and the elevation of the upper surface 52 or the edge 34 of the component 22 or between the bottom 56 of the gap 20 and the elevation of the upper surface 54 or the edge 38 of the component 24.

Propagating the directional light into the field of view 80 below the elevation levels of the upper surfaces 52 or 54 or below the edges 34 or 38 enhances contrast between the bottom 56 of the gap 20 and the upper surfaces 52 and 54 of the respective components 22 and 24.

In some embodiments, the directional light has a first central lighting axis 82a extending from the light source 76, and the first central lighting axis 82a has a vector component that is parallel to the major axis 46. In some embodiments, the directional light has a second central lighting axis from a second light source 82b (82a and 82b my be generically or collectively denoted as 82). In some additional or cumulative embodiments, the first and second lighting axes 82 enter the gap 20 from different directions. In some additional or cumulative embodiments, the first and second lighting axes 82 enter the gap 20 from opposing sides of the field of view 80. In some additional or cumulative embodiments, the first and second lighting axes 82 enter the gap 20 from opposing sides of the gap 20. In some additional or cumulative embodiments, the opposing sides of the gap 20 are transverse to the edges 34 and 38. In some additional or cumulative embodiments, the opposing sides of the gap 20 are perpendicular to an axial direction of one or both of the edges 34 and 38.

In some additional or cumulative embodiments, the edge 34 defines a side wall axis 88 along the side wall 32, and the side wall 32 defines a side wall plane 90 (coplanar with the side wall axis 88 and directed into the page of FIG. 1) that is generally perpendicular to the upper surface 52. The side wall axis 88 may be collinear with the second minor axis 48. In some additional or cumulative embodiments, the edge 38 defines a side wall axis 92 along the side wall 36, and the side wall 36 defines a side wall plane 94 (coplanar with the side wall axis 92 and directed into the page of FIG. 1) that is generally perpendicular to the upper surface 54. In some additional or cumulative embodiments, the lighting axis 82a is positioned within a first lighting axis plane (not shown) between the side wall plane 90 and the side wall plane 94. In some additional or cumulative embodiments, the lighting axis 82b is positioned within a second lighting axis plane (not shown) between the side wall plane 90 and the side wall plane 94. In some additional or cumulative embodiments, the first and second lighting axes 82 are oriented at nonperpendicular angles with respect to at least one of the upper surface 52 and the upper surface 54. An advantage of the directional light having a direction predominantly or substantially parallel to the side walls 32 and 36 is that reflections off the side walls 32 and 36 are reduced, thereby minimizing such side-wall reflections that reach the imager 70. The minimization of the side-wall reflections eases performance constraints on the imager 70 and helps to provide better defined images of the boundaries between the gap 20 and the edges 34 and 38. Moreover, reduction in side-wall reflections facilitates greater accuracy in the determination of the boundaries between the gap 20 and the edges 34 and 38.

In some additional or cumulative embodiments, the lighting axis 82a is positioned within a third lighting axis plane (not shown) that is transverse to the first lighting axis plane, the lighting axis 82b is positioned within a fourth lighting axis plane (not shown) that is transverse to the second lighting axis plane (not shown), and the third and fourth lighting axis planes intersect each other below the bottom of the gap.

In some additional or cumulative embodiments, the lighting axis 82a is positioned within a third lighting axis plane that is transverse to the first lighting axis plane, the lighting axis 82b is positioned within a fourth lighting axis plane that is transverse to the second lighting axis plane, and the third and fourth lighting axis planes intersect each other above the bottom of the gap.

In some additional or cumulative embodiments, the directional light or its lighting axis 82 impinges the bottom 56 of the gap 20 at an angle between 5 and 70 degrees. In some additional or cumulative embodiments, the directional light or its lighting axis 82 impinges the bottom 56 of the gap 20 at an angle between 10 and 65 degrees. In some additional or cumulative embodiments, the directional light or its lighting axis 82 impinges the bottom 56 of the gap 20 at an angle between 10 and 50 degrees. In some additional or cumulative embodiments, the directional light or its lighting axis 82 impinges the bottom 56 of the gap 20 at an angle between 20 and 50 degrees. In some additional or cumulative embodiments, the directional light or its lighting axis 82 impinges the bottom 56 of the gap 20 at an angle between 30 and 50 degrees. In some additional or cumulative embodiments, the directional light or its lighting axis 82 impinges the bottom 56 of the gap 20 at an angle between 40 and 50 degrees.

FIG. 2A depicts exemplary radiation patterns 100a and 100b of the directional light from respective light sources 76a and 76b as if the directional light traversed the field of view 80 above the upper surfaces 52 and 54 of the respective components 22 and 24. While some of the directional light may traverse the field of view 80 above the upper surfaces 52 and 54, it is preferred that most of the directional light (from the directional light sources 76) traversing the field of view 80 enters the field of view 80 below the elevations of the upper surfaces 52 and 54, as previously discussed.

FIG. 2D is a top plan view of an alternative exemplary embodiment of an irradiation pattern from a single light source of the inspection system 44. FIG. 2E is a top plan view of an alternative exemplary embodiment of an irradiation pattern from a different direction than that of the single light source in FIG. 2E. FIG. 2F is a top plan view of an alternative exemplary embodiment of an irradiation pattern from both the light sources shown in FIGS. 2D and 2E. With reference to FIGS. 2C and 2D, the light source 76a is positioned and configured to provide emission ray boundaries 102 that intersect the field of view 80 below the elevations of the upper surfaces 52 and 54. The directional light from the light source 76a thereby produces an exemplary radiation pattern 100a that includes radiation subpatterns 100a₁ and 100a₂. Radiation subpattern 100a₁ shows directional light that impinges the upper surfaces 52 and 54, as well as the bottom 56 of the gap 20, outside of the field of view 80 of the imager 70. Radiation subpattern 100a₂ shows directional light that impinges the bottom of the gap 56 within and beyond the field of view 80 of the imager 70. With reference to FIGS. 2C and 2E, the light source 76b is positioned and configured to provide the emission ray boundaries 102 that intersect the field of view 80 below the elevations of the upper surfaces 52 and 54. The directional light from the light source 76b thereby produces an exemplary radiation pattern 100b that includes radiation subpatterns 100b₁ and 100b₂. Radiation subpattern 100b1 shows directional light that impinges the upper surfaces 52 and 54, as well as the bottom 56 of the gap 20, outside of the field of view 80 of the imager 70. Radiation subpattern 100b2 shows directional light that impinges the bottom of the gap 56 within and beyond the field of view 80 of the imager 70.

With reference to FIGS. 2C and 2F, the light sources 76a and 76b provide directional light that thereby produces an exemplary combined radiation pattern 100 that includes the radiation patterns 100a and 100b. The combined radiation pattern 100 provides bright illumination to the gap 20 within the field of view 80 without significantly illuminating the upper surfaces 52 and 54 (so that the side walls 32 and 36 are imaged by the imager 70 as a dark line) to provide contrast between the gap 20 and the upper surfaces 52 and 54 in order to facilitate differentiation by the imager 70 between the gap 20 and the upper surfaces 52 and 54.

In some embodiments, the radiation patterns 100a and 100b overlap only slightly within the field of view 80. In some additional or cumulative embodiments, the radiation patterns 100a and 100b overlap along the full length 110 (aligned along the major axis 46 of the gap 20) of the field of view 80. In some additional or cumulative embodiments, the radiation patterns 100a and 100b overlap within and beyond the full length 110 of the field of view 80. As stated previously, overlap of the radiation patterns 100a and 100b entering the field of view 80 from opposite directions provides the advantage of eliminating shadows cast by imperfections in the surface at the bottom 56 of the gap 20 or shadows caused by imperfections in the directional light provided by one of the light sources 76a or 76b.

In some embodiments, the directional light comprises a spot light. In some additional or cumulative embodiments, the light source 76 comprises an LED, an optical fiber, or a laser. The light sources 76 may include optical component(s) for shaping, focusing, or directing the directional light, or the optical components can be deployed along the path of the light emitted from the light sources 76.

With reference again to FIGS. 2A-2F (collectively FIG. 2), in some embodiments, the imager 70 comprises a camera. In some additional or cumulative embodiments, the imager 70 comprises a CCD image sensor or an active pixel sensor, such as a CMOS sensor, a BSI-CMOS, an NMOS sensor, or a hybrid CCD/CMOS sensor. In some additional or cumulative embodiments, the imager 70 is arranged so that the field of view 80 is at least substantially perpendicular to the bottom 56 of the gap 20. In some additional or cumulative embodiments, the imager 70 is arranged so that the field of view 80 is perpendicular to the bottom 56 of the gap 20.

It will be appreciated that in the figures, the components 22 and 24 and the gap 20 are not drawn to scale. Moreover, the light sources 76 and the imager 70 are not drawn to scale and are not drawn at the same scale as the components 22 and 24. For convenience, the imager 70 is shown to have the same cross-sectional area as the field of view 80; however, in some embodiments, the imager 70 has dimensions that are much bigger than the area of the field of view 80 and employs a magnifying lens to capture an image of the gap 20.

In some additional or cumulative embodiments, the field of view 80 has a diameter or width dimension 112 (such as coplanar with the first minor axis 30 of the gap 20) that is larger than the width of the gap 20. In some additional or cumulative embodiments, the width dimension 112 is greater than at least twice the width of the gap 20. In some additional or cumulative embodiments, the width dimension 112 is greater than at least three times the width of the gap 20. In some additional or cumulative embodiments, the width dimension 112 is shorter than five times the width of the gap 20.

In some embodiments, the field of view 80 may have a width dimension 112 that is between 1 μm and 5000 μm. In some embodiments, the width dimension 112 is shorter than 2000 μm and greater than 1 μm. In some embodiments, the width dimension 112 is shorter than 1000 μm and greater than 5 μm. In some embodiments, the width dimension 112 is shorter than 500 μm and greater than 5 μm. In other embodiments, the width dimension 112 is shorter than 250 μm and greater than 5 μm. In yet other embodiments, the width dimension 112 is shorter than 100 μm and greater than 5 μm. In still other embodiments, the width dimension 112 is shorter than 50 μm and greater than 5 μm. In some other embodiments, the width dimension 112 could be greater than 5000 μm.

In some embodiments of an inspection process, the workpiece 26 is positioned in an inspection area of an inspection station so that the gap 20 is aligned within the field of view 80 of the imager 70. This operation may be performed by a workpiece handling or positioning system. In some additional or cumulative embodiments, the inspection station includes one or more guide walls (not shown) to abut against outer surfaces of the workpiece 26, such as the outer surfaces of the housing component 24. In some additional or cumulative embodiments, the workpiece 26 may be gravity fed into the inspection station to abut against the guide walls. In some additional or cumulative embodiments, the workpiece may be moved on an indexed fixture (such as conveyed by a conveyor belt or a loading or unloading system) into the inspection position, and the workpiece may be prealigned to the indexed fixture or aligned just prior to inspection. In some additional or cumulative embodiments, an optical alignment system may be employed to determine whether the workpiece 26 is adequately aligned for inspection, and the workpiece handling or positioning system may adjust the position of the workpiece 26 with respect to the field of view 80.

In some additional or cumulative embodiments, the inspection module 42 or the imager 70 may be moved by a module positioning system to be in alignment with the gap 20 of a workpiece 26. In some additional or cumulative embodiments, a workpiece handling and positioning system is employed in conjunction with a positioning system for the module(s) 42. In some additional or cumulative embodiments, the workpiece 26 is positioned in an inspection station so that multiple gap positions, such as gap positions 20₁-20₈, are aligned with multiple respective inspection modules 42, such as modules 42₁-42₈. In some additional or cumulative embodiments, at least one gap position (20₁, 20₃, 20₅, 20₇) of each linear gap 20 is aligned to be inspected. In some additional or cumulative embodiments, at least two spaced-apart gap positions (20₁-20₈) of each linear gap 20 are aligned to be inspected. In some additional or cumulative embodiments, at least one inspection module 42 is employed for each side of the workpiece 26. In some additional or cumulative embodiments, at least two inspection modules 42 are employed for each side of the workpiece 26.

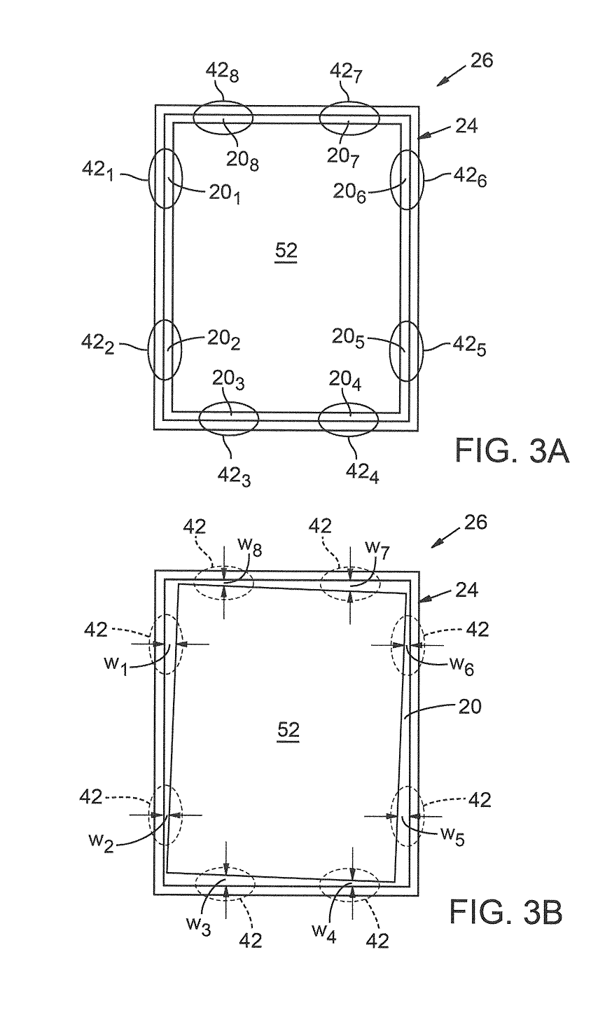

FIG. 3A is a top view of an embodiment wherein the gap positions 20₁-20₈, are aligned with multiple respective fields of view 80 of modules 42₁-42₈ to permit the multiple gaps 20₁-20₈ to be inspected simultaneously. In some additional or cumulative embodiments, some of the gaps positions 20₁-20₈ are transversely aligned. In some additional or cumulative embodiments, each of the gaps positions 20₁-20₈ is positioned within a field of view 80 of a separate imager 70. In some additional or cumulative embodiments, an imager 70 may be positioned, such as between two of the linearly aligned gaps positions 20₁-20₈, so that the field of view 80 of the imager 70 can be diverted by a split mirror along divergent imaging paths with a plurality of fold mirrors, such that two or more gap positions 20₁-20₈ can be simultaneously imaged by different imaging fields on the imager 70. Detailed information about the use of split mirrors and divergent imaging paths can be found in U.S. Pat. No. 8,322,621, the text of which is incorporated herein by reference.

FIG. 3B is a top view of an embodiment wherein the component 22 is misaligned with respect to component 24 so that the widths of the gaps 20 at the gap positions 20₁-20₈ are different. Measuring the gap at a variety of gap positions 20₁-20₈ procures information about the nature of the misalignment of the component 22 with respect to the component 24 so that the misalignment can be corrected or so that the workpiece 26 can be rejected if it does not satisfy quality criteria.

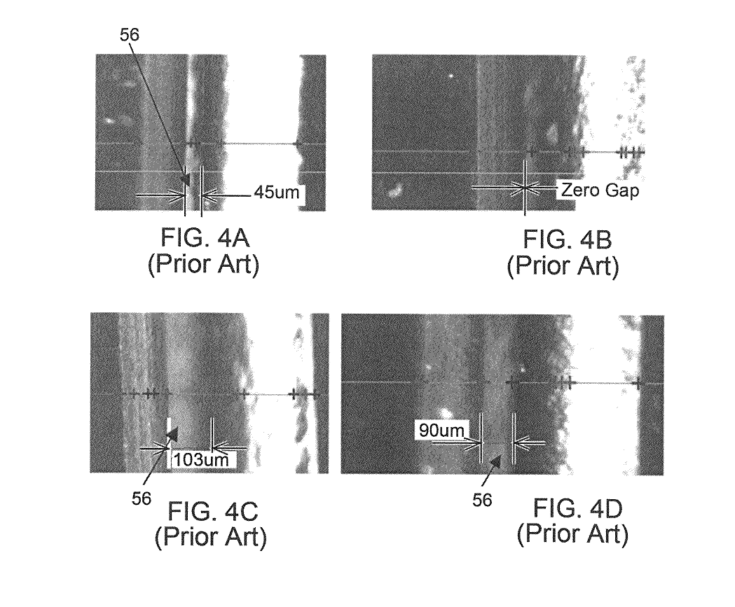

FIGS. 4A to 4D are prior art images of gaps 20 between components 22 and 24 of workpieces 26, illuminated by area lighting whose radiation pattern impinges substantially the entire upper surfaces 52 and 54 of the respective components 22 and 24 forming the gaps 20. Area lighting is conventionally supplied by a ring of point source lights positioned well above the workpiece 26. Such lighting system tends to create shadows and cause noise. As illustrated in the images, the bottom 56 of the gap 20 can be imaged using area lighting, but the contrast between the bottom 56 and the adjacent components 22 and 24 is low, preventing accurate determination of the locations of the side walls 32 and 36 thereby preventing accurate determination of the width of the gap 20.

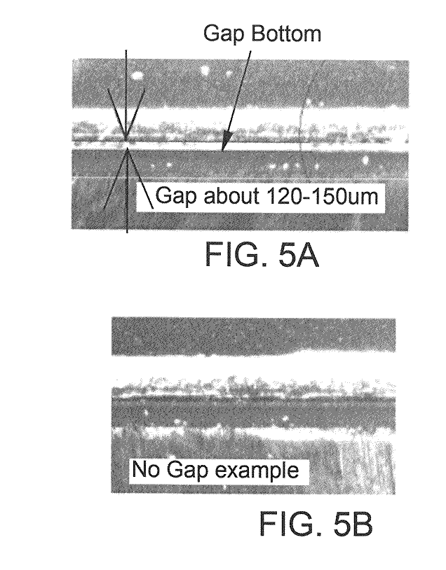

FIG. 5A is an image of a gap 20 between components of a workpiece 26 illuminated by directional lighting whose radiation pattern 100 impinges substantially only the gap 20 within the field of view 80 of the imager 70. FIG. 5B is an image of two abutting components 22 and 24 of the workpiece 26 illuminated by directional light whose radiation pattern impinges the workpiece 26 substantially outside the field of view 80 of the imager 70. These images were obtained by illuminating the workpiece 26 in the manner described with respect to FIGS. 2A to 2F and then capturing the image of the reflected light using the imager 70. As illustrated in FIGS. 5A and 5B, the contrast between the bottom 56 of the gap 20 and the upper surfaces 52 and 54 of the components 22 and 24 adjacent to the gap 20 is higher than that shown in FIGS. 4A to 4D, making it easier to adequately determine the width of the gap 20.

Although the image formed by employing multiple directional lights greatly improves contrast between the gap 20 and the components 22 and 24, particles or surface imperfection at the bottom 56 of the gap 20 can, in some cases, make the image of the bottom 56 appear uneven.

To increase reliability and accuracy of gap width measurements, images captured by the imager 70 may be spatially integrated to improve the imaged contrast difference between the bottom 56 of the gap 20 and the area of the workpiece 26 adjacent to the gap 20 and ensure that imaged contrast difference is suitably large and uniform along the length of the gap 20.

In some additional or cumulative embodiments, spatial integration may be performed using known mathematical and/or software techniques. For example, in some additional or cumulative embodiments, the imager 70 includes an array of pixels along rows and columns that convey gray scale or intensity information of the image. The gray scale or intensity information can be grouped by rows of pixels to facilitate determination of spacing between the edges 34 and 38. The analysis may include groupings of rows of pixels at an angle to the major axis, as well as grouping of rows of pixels parallel to the major axis 46, to determine whether the edges 34 and 38 of the gap 20 are not parallel to each other.

For some additional or cumulative embodiments, the gaps 20 are analyzed to determine whether the gap widths for a given workpiece 26 all have values that fall within a predetermined range. In some additional or cumulative embodiments, the acceptable gap widths are from 0 to 250 μm. In some additional or cumulative embodiments, the acceptable gap widths are from 0 to 200 μm. In some additional or cumulative embodiments, the acceptable gap widths are from 0 to 150 μm. In some additional or cumulative embodiments, the predetermined range of acceptable gap widths is from 10 to 175 μm. In some additional or cumulative embodiments, the predetermined range of acceptable gap widths is from 20 to 150 μm. In some additional or cumulative embodiments, the predetermined range of acceptable gap widths is from 30 to 125 μm. In some additional or cumulative embodiments, the predetermined range of acceptable gap widths is from 40 to 100 μm.

In some additional or cumulative embodiments, the contrast can be weighted or be converted to one-bit bi-tonal images. In some additional or cumulative embodiments, the gray scale may be designated on a scale from 0 to 1, wherein zero represents black and 1 represents white (or the inverse). In some additional or cumulative embodiments, the gray scale may be designated on a scale from 0 to 100. In some additional or cumulative embodiments, the gray scale may be designated on a scale from 0 to 256. In some additional or cumulative embodiments, the gray scale may be implemented using 8 bits, 16 bits, or 32 bits. In some additional or cumulative embodiments, the gray scale may incorporate colorimetric data.

In some additional or cumulative embodiments, the contrast between the gap 20 and the edges 34 and 38 is greater than 50%. In some additional or cumulative embodiments, the contrast between the gap 20 and the edges 34 and 38 is greater than 75%. In some additional or cumulative embodiments, the contrast between the gap 20 and the edges 34 and 38 is greater than 80%. In some additional or cumulative embodiments, the contrast between the gap 20 and the edges 34 and 38 is greater than 90%.

In some additional or cumulative embodiments, the grey scale or intensity information of the groups of pixels can be averaged. The averages of the groups of pixels can then be compared against each other to facilitate determination of spacing between the edges 34 and 38. For example, lighter intensity rows will have much greater and more easily discernable contrast with darker intensity rows.

In some additional or cumulative embodiments, relative movement between the workpiece 26 and the imager 70 along the major axis 46 can be implemented while the imager 70 is capturing images to facilitate determination of spacing between the edges 34 and 38. In some additional or cumulative embodiments, the imager 70 can be fixed in a position and the workpiece 26 can be moved. In some additional or cumulative embodiments, the workpiece 26 can be fixed in a position and the imager 70 can be moved.

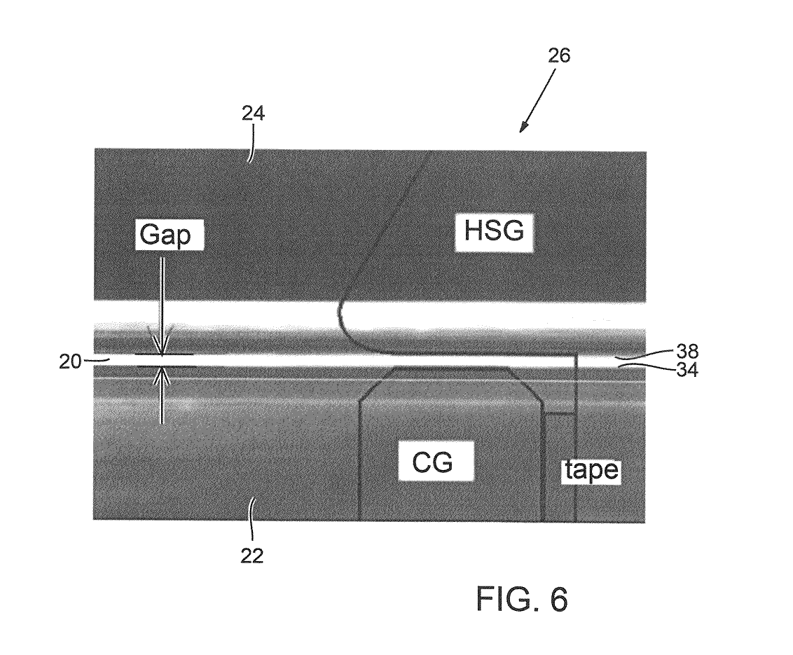

FIG. 6 illustrates a spatially-integrated image of the gap 20 between components 22 an 24 of a workpiece 26 similar to those schematically illustrated in FIG. 2. For ease or reference, the spatially-integrated image is overlaid with an aligned schematic of the cross-sectional view of the workpiece from FIG. 2B. The spatially-integrated image was obtained by illuminating the bottom 56 of the gap 20 in the manner described with respect FIG. 2 and moving the module 42 of the inspection system 44 along the a portion of the major axis 46, as previously discussed. As illustrated, the contrast between the bottom 56 of the gap 20 and the edges 34 and 38 of the respective components 22 and 24 of the workpiece 26 adjacent to the gap 20 is higher than that shown in FIG. 4 or 5, further facilitating the determination of the width of the gap 20.

With reference to FIG. 1, the components 22 and 24 may be assembled so that the upper surface 52 of the component 22 may have an elevation that is the same as or different from that elevation of the upper surface 54 of the component 24. In some additional or cumulative embodiments, the inspection system 44 can be adapted to illuminate and capture images to determine the height difference “h” between the upper surfaces 52 and 54. In some additional or cumulative embodiments, the height difference between the upper surfaces 52 and 54 can be observable as a protrusion 120 of the upper surface 52 of the component 22 above the upper surface 54 of the component 24. Variations in thickness or defects in the adhesive layer 28 (or other assembly steps or process) can cause varying elevation in the upper surface 52. These elevation variations can be visible to the human eye or discernable by human touch and may detract from the cosmetic appeal of the workpiece 26.

It will be appreciated that the gap 20 and the protrusion 120 are presented herein only by way of example to different features that can be illuminated and imaged by the inspection station 44. Moreover, a feature can refer to one or more cracks, bumps, gaps, ridges, trenches, holes, slots, textures, surface finishes, visible indicia, or the like or a combination thereof. In some additional or cumulative embodiments, two or more of the different features are positioned on transverse surfaces. In some additional or cumulative embodiments, the different features cannot be adequately viewed from a single direction. Moreover, in some additional or cumulative embodiments, the different features can adequately be viewed only from different directions.

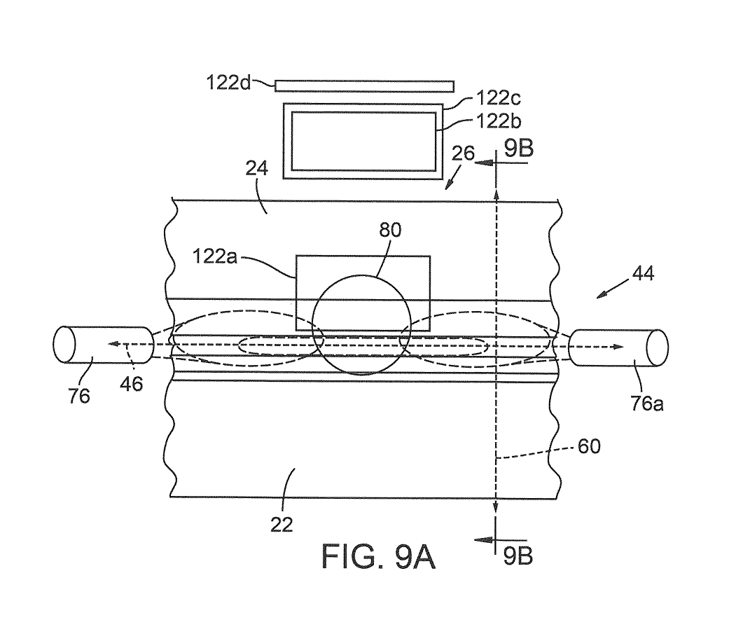

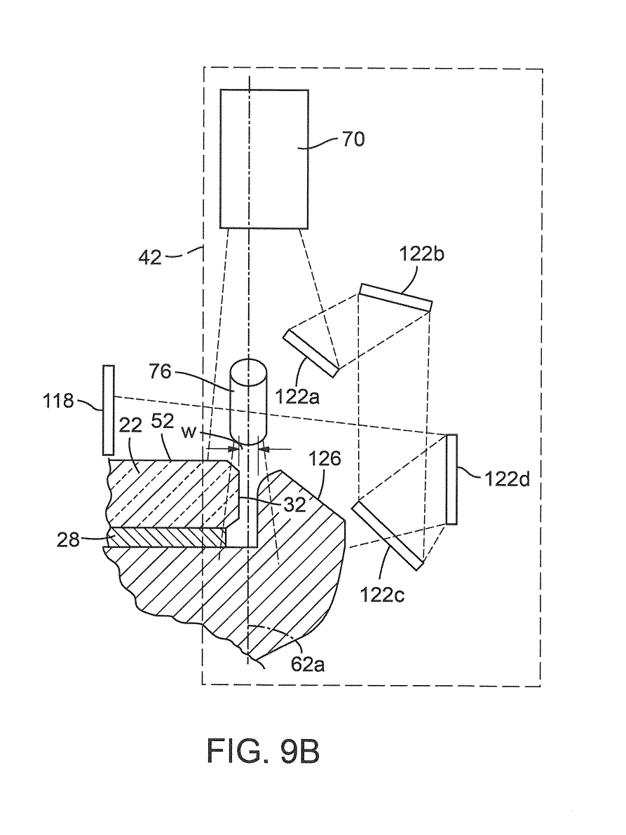

FIG. 7 is a top plan view of an exemplary embodiment of an inspection system 44 adapted to inspect multiple features, such as the gaps 20 and the protrusions 120, of the workpiece 26 from different directions. FIG. 8 is an illustration of an imaging field 130 of an imager 70 operable for capturing images of the gap 20 and the protrusion 120 in different imaging regions 132a and 132b. FIGS. 9A and 9B are top and side views of an alternative exemplary embodiment of an inspection system 44 adapted to inspect multiple features, such as the gaps 20 and the protrusions 120, of the workpiece 26 from different directions.

With reference to FIGS. 1, 2, 7, 8, and 9, the imager 70 (or exemplary imagers 70₁-70₄), the light sources 76a and 76b, and one or more fold mirrors 122 (such as 122a-122d) can be positioned so that the field of view 80 of each imager 70 is operable to capture images of both the gap 20 and the protrusion 120, such that an imaging field 130 of the imager 70 is split into two imaging regions 132a and 132b (i.e., the array of pixels is divided into a plurality of imaging regions 132 wherein the imaging region 132a is operable to capture an image of the protrusion 120 and wherein the imaging region 132b is operable to capture an image of the gap 20). In some additional or cumulative embodiments, the imager 70 can be positioned to have a direct field of view 80 of the gap 20 (so that the field of view 80 captures the gap 20 from a perpendicular or near perpendicular perspective, for example), such as shown in FIG. 9, and an indirect field of view 80 of the protrusion 120. In such embodiments, the one or more fold mirrors 122 are positioned to intercept a portion (such as one half) of the field of view 80 so that it captures the protrusion 120 from a perpendicular or near perpendicular perspective, for example.

In some additional or cumulative embodiments, the protrusion 120 can be illuminated and analyzed in a manner similar to the techniques used to illuminate and analyze the gap 20. For example, one or more optional additional light sources 76a and 76b can be employed to provide directional light so that it substantially illuminates only the protrusion 120 of the side wall 32 of the component 22 within the field of view 80 without substantially illuminating an adjacent outer surface 126 of the component 24 within the field of view 80. Moreover, the directional light can enter the field of view 80 at an angle such that it intercepts the field of view 80 only between the respective planes of the side walls 32 and 36. In this manner, the protrusion 120 can be illuminated without substantially illuminating the outer surface 126 within the field of view 80. A dark barrier 118 can be positioned to absorb any of (or all of) the directional light propagating above the surface 52 of the component 22 so that each side of the protrusion 120 appears dark and provides a high contrast with the protrusion 120. It will be appreciated that a single set of directional light sources 76a and 76b can be employed and that the fold mirror(s) 122 (or additional fold mirrors) can be positioned to split the radiation pattern from the light sources 76a and 76b so that they directionally illuminate the gap 20 and the protrusion 120 from the desired directions.

In some additional or cumulative embodiments, the imager 70 can be positioned to have a direct field of view 80 of the protrusion 120 (so that the field of view 80 captures the protrusion 120 from a perpendicular or near perpendicular perspective, for example), and an indirect field of view 80 of the gap 20. In such embodiments, the one or more fold mirror(s) 122 are positioned to intercept a portion (such as one half) of the field of view 80 so that it captures the gap 20 from a perpendicular or near perpendicular perspective, such as shown in FIG. 7 for example.

In some additional or cumulative embodiments, the images of the gap 20 and the protrusion 20 can be obtained either substantially simultaneously or sequentially. In some additional or cumulative embodiments, the imager 70 can capture simultaneous images on the separate imaging regions 132a and 132b. In some additional or cumulative embodiments, the imager 70 can capture sequential images on the separate imaging regions 132a and 132b, or the imager 70 can capture sequential images on the entire imaging field 130. In some additional or cumulative embodiments, the directional lighting can be supplied either simultaneously or sequentially by the same directional light sources 76 or separate light sources 76 in coordination with image capture. In some additional or cumulative embodiments, one or more lenses 128 associated with the imager 70 can be moved toward or away from the workpiece 26 to adjust the focal length for sequential image capture.

FIG. 10 is a top view of another alternative embodiment of an inspection system 44 adapted to inspect multiple features 140 and 142, such as two top features, two side features, or a top feature and a side feature, of the workpiece 26 from different directions. With reference to FIG. 10, the imager 70 is positioned to have a perspective of an outside corner of the component 24. In particular, the imager 70 has a perspective that views the outside surface 126 of the component 24 to capture an image of the feature 142, and the perspective also views a reflection of the feature 140 in the mirror 122.

Software algorithms can be used to calculate the location and/or dimensions of the imaged features from the split imaging regions 132a and 132b. To make the features 140 and 142 at different locations of the object be at similar focal distances from the imager 70, the location of the mirror(s) 122 can be advantageously selected. Thus, a single imager 70 can be used to measure different types of features located at different regions of the workpiece 26. It is noted that the imaging fields 130 can be divided in more than two imaging regions 132, and the imaging regions 132 can have different sizes. For example imaging regions 132 employed for capturing gaps 20 can be smaller than those employed for capturing protrusions 120. Moreover, the embodiments described permit more numerous and accurate inspection and measurement while minimizing the number of imager and illumination components and costs.

FIG. 11 is a top view of another alternative embodiment of an inspection system 44 adapted to inspect multiple features at multiple separate locations on the workpiece 26. With respect to FIG. 11, the workpiece 26 can be of any configuration and can have a variable number of sides of the same or different lengths. The number of imagers 70 and/or the number of split imaging fields 132 and mirrors 122 can be adjusted to minimize extra movement of the workpiece 26 to reduce or eliminate costly motion actuators (not shown).

The inspection system 44 as exemplarily described in the embodiments presented herein can be advantageously used to provide a fast, simple, and low cost measurement of device features.

The foregoing is illustrative of embodiments of the invention and is not to be construed as limiting thereof. Although a few specific example embodiments have been described, those skilled in the art will readily appreciate that many modifications to the disclosed exemplary embodiments, as well as other embodiments, are possible without materially departing from the novel teachings and advantages of the invention.

Accordingly, all such modifications are intended to be included within the scope of the invention as defined in the claims. For example, skilled persons will appreciate that the subject matter of any sentence or paragraph can be combined with subject matter of some or all of the other sentences or paragraphs, except where such combinations are mutually exclusive.

It will be obvious to those having skill in the art that many changes may be made to the details of the above-described embodiments without departing from the underlying principles of the invention. The scope of the present invention should, therefore, be determined by the following claims, with equivalents of the claims to be included therein.

1. A method for measuring a first dimension along a first minor axis of a feature adjacent to a first edge of a first surface of a workpiece, wherein the first surface has a first plane, wherein the feature includes a length along a major axis that is transverse to the first minor axis, wherein the feature has a second dimension along a second minor axis that is transverse to the major axis and the first minor axis, wherein the second dimension extends from the first surface to a recessed surface of the feature, wherein the recessed surface of the feature has a recessed plane, the method comprising:
employing an imager having a field of view of an inspection area;
positioning the workpiece in an inspection position such that the first minor axis of the feature is located within the field of view of the imager;
propagating directional light onto the feature, such that a major portion of the directional light entering the field of view of the imager propagates into the field of view between the recessed plane and the first plane;
capturing with the imager an image of light reflected from the recessed surface of the feature; and
analyzing differences in luminance and/or color between the recessed surface of the feature and the surface of the workpiece to facilitate determination of a measurement of the first dimension of the feature.

2. The method of claim 1, wherein the first surface is a first upper surface, wherein the first plane has a first elevation, wherein the first dimension is a width, wherein the workpiece has a second upper surface with a second edge spaced apart from the first edge, wherein the second upper surface has a second plane having a second elevation, wherein the second dimension is a depth, wherein the feature is a gap, wherein the recessed surface is a bottom of the gap, wherein the recessed plane has a bottom elevation, and wherein differences in luminance and/or color between the bottom surface of the gap and the second upper surface of the workpiece are also analyzed.

3. The method of claim 1, wherein the directional light is focused onto the recessed surface.

4. The method of claim 1, wherein the first dimension of the feature and the second dimension of the feature are shorter than the length of the feature.

5. The method of claim 1, wherein the first dimension of the feature is shorter than the second dimension of the feature.

6. The method of claim 1, wherein the imager includes an array of pixels along rows and columns, wherein the pixels convey gray scale or intensity information of the image, and wherein analyzing differences includes grouping the gray scale or intensity information by rows of pixels parallel to the major axis to facilitate determination of the first dimension.

7. The method of claim 6, wherein analyzing differences includes averaging the gray scale or intensity captured by pixels along the rows parallel to the major axis to facilitate determination of the first dimension.

8. The method of claim 1, wherein the imager includes an array of pixels along rows and columns, and wherein relative movement between the workpiece and the imager along the major axis is implemented to facilitate determination of the first dimension.

9. The method of claim 1, wherein the directional light has a central lighting axis extending from a light source, and wherein the lighting axis has a vector component that is parallel to the major axis.

10. The method of claim 1, wherein the field of view has a width dimension that is coplanar with the first minor axis of the feature, and wherein the width dimension of the field of view is shorter than five times the first dimension of the feature.

11. The method of claim 1, wherein the directional light has a first central lighting axis extending from a first light source, wherein the directional light has a second central lighting axis from a second light source, wherein the first and second lighting axes approach the feature from different directions, wherein the first edge defines a first wall plane along a first side wall that is generally perpendicular to the first surface, wherein a second edge of a second surface defines a second wall plane along a second side wall that is generally perpendicular to the second surface, wherein the first lighting axis is positioned within a third plane between the first and second wall planes, wherein the second lighting axis is positioned within a fourth plane between the first and second wall planes, and wherein the first and second lighting axes are oriented at nonperpendicular angles with respect to the first or second surfaces.

12. The method of claim 1, wherein the first dimension is between zero and 500 μm.

13. The method of claim 1, wherein the second dimension is between 500 μm and 2 mm.

14. The method of claim 1, wherein the light source comprises an LED, optical fiber, or a laser.

15. The method of claim 1, wherein the workpiece includes a plurality of features, including first and second gaps that are transversely aligned, wherein the directional light propagates from a light source, wherein the imager and the light source form an inspection module, and wherein the first and second gaps are inspected by separate inspection modules.

16. The method of claim 1, wherein the workpiece includes a plurality of features, including first and second gaps that are transversely aligned, wherein capturing the image employs an imager having an array of pixels along rows and columns, wherein the array of pixels is divided into a plurality of imaging fields including first and second imaging fields, wherein the first imaging field captures a first image of the first gap, and wherein the second imaging field captures a second image of the second gap.

17. The method of claim 2, wherein the first upper elevation of the first surface is different from the second upper elevation of the second surface, wherein a difference between first and second upper elevations defines a protrusion, wherein capturing the image employs a camera having an array of pixels along rows and columns, wherein the array of pixels is divided into a plurality of imaging fields including first and second imaging fields, wherein the first imaging field captures the image of the gap, wherein the second imaging field captures a second image of the protrusion, and wherein data from the second image is used to determine a height difference between the first and second elevations.

18. The method of claim 1, wherein the major portion of the directional light illuminating the field of view of the imager propagates into the field of view between the recessed surface and the first surface.

19. A system for measuring a width along a first minor axis of a gap between a first edge of a first upper surface and a second edge of a second upper surface of a workpiece, wherein the first upper surface has a first upper elevation, wherein the second upper surface has a second upper elevation, wherein the gap includes a length along a major axis that is transverse to the first minor axis, wherein the gap has a depth along a second minor axis that is transverse to the major axis and the first minor axis, wherein the depth extends from at least one of the first or second upper surfaces to a bottom of the gap, wherein the bottom of the gap has a bottom elevation, wherein the width and depth are shorter than the length, the system comprising:
an imager, having a field of view of an inspection area, for capturing an image of light reflected from the bottom of the gap;
a lighting system operable for emitting directional light to illuminate to the bottom of the gap, wherein the lighting system is operable to direct the directional light to enter the field of view of the imager such that a major portion of the directional light entering the field of view is directed to enter the field of view between the bottom elevation and the first upper elevation or the second upper elevation;
a workpiece positioning mechanism operable for positioning the workpiece in an inspection position such that the first minor axis of the gap is located within the field of view of the imager; and
processing circuitry operable for analyzing differences in luminance and/or color between the bottom surface and the first and second upper surfaces to facilitate determination of a measurement of the width of the gap.

20. A method for measuring a first dimension along a first minor axis of a first feature adjacent to a first edge of a first surface of a workpiece and for measuring and for measuring a third dimension along a third minor axis of a second feature adjacent to a second edge of a second surface of the workpiece, wherein the first surface has a first plane, wherein the first feature includes a first length along a first major axis that is transverse to the first minor axis, wherein the first feature has a second dimension along a second minor axis that is transverse to the first major axis and the first minor axis, wherein the second dimension extends from the first surface to a first recessed surface of the first feature, wherein the first recessed surface of the first feature has a first recessed plane, wherein the second surface has a second plane, wherein the second feature includes a second length along a second major axis that is transverse to the third minor axis, wherein the second feature has a fourth dimension along a fourth minor axis that is transverse to the second major axis and the third minor axis, wherein the fourth dimension extends from the second surface to a second recessed surface of the second feature, wherein the second recessed surface of the second feature has a second recessed plane, and wherein the first and second recessed planes are transverse, the method comprising:
employing an imager having a field of view of an inspection area;
positioning the workpiece in an inspection position such that the first minor axis of the first feature is located within the field of view of the imager;
employing a mirror to divert a portion of the field of view such that the third minor axis of the second feature is located within the diverted portion of the field of view of the imager;
propagating directional light onto the first and second features;
capturing with the imager a first image of light reflected from the first recessed surface of the first feature on a first imaging region of the imager;
simultaneously or sequentially capturing with the imager a second image of light reflected from the second recessed surface of the second feature on a second imaging region of the imager;
analyzing differences in luminance and/or color between the first recessed surface of the first feature and the first surface of the workpiece to facilitate determination of a first measurement of the first dimension of the first feature; and
analyzing differences in luminance and/or color between the second recessed surface of the second feature and the second surface of the workpiece to facilitate determination of a second measurement of the third dimension of the second feature.
